(19) United States
(12) Patent Application Publication
(10) Pub. No.: US 2011/0299645 A1
(43) Pub. Date: Dec. 8, 2011

(54) Breeding Nuclear Fuel Mixture Using Metallic Thorium

(75) Inventors: Dae-Ho Kim, Daejeon (KR); Je-Geon Bang, Daejeon (KR); Yang-Hyun Koo, Daejeon (KR); Ik-Sung Lim, Daejeon (KR); Sun-Ki Kim, Deajeon (KR); Yong-Sik Yang, Daejeon (KR); Kun-Woo Song, Daejeon (KR)

(73) Assignees: Korea Hydro & Nuclear Power Co., Ltd., Seoul (KR); Korea Atomic Energy Research Institute, Daejeon (KR)

(21) Appl. No.: 13/152,884

(22) Filed: Jun. 3, 2011

(30) Foreign Application Priority Data
Jun. 7, 2010 (KR) 2010-0053484
May 24, 2011 (KR) 2011-0049064

(51) Int. Cl. G21G 1/06; G21C 3/32; G21C 3/36; G21C 3/02

(52) U.S. Cl. 376/172; 376/411; 376/434; 376/412; 376/432

(57) ABSTRACT

Disclosed is a breeding nuclear fuel mixture including metallic thorium useable in a nuclear power plant, prepared by mixing uranium dioxide (UO₂) or plutonium dioxide (PuO₂) having ceramic properties with metallic thorium (Th), in order to enable thorium breeding by neutrons released during nuclear fission of U or Pu and conversion of the bred thorium into a novel nuclear fissile material, i.e., U-233, thereby ensuring continuous nuclear fission. The foregoing nuclear fuel mixture may be burned at a reactor core of a nuclear power plant through thorium breeding over a long period of time. Therefore, when the inventive breeding nuclear fuel mixture is employed in a nuclear power plant, utilization of the nuclear power plant may be increased while maximizing conservation of limited uranium resources.

### CROSS-REFERENCE TO RELATED APPLICATIONS

This application claims priority from Korean Patent Application No. 2010-0053484, filed on Jun. 7, 2010 and Korean Patent Application No. 2011-0049064, filed on May 24, 2011 in the Korean Intellectual Property Office, the entire disclosures of which are incorporated herein by reference.

### BACKGROUND OF THE INVENTION

1. Field of the Invention

The present invention relates to a breeding nuclear fuel containing metallic thorium and, more particularly, to a breeding nuclear fuel mixture containing metallic thorium, prepared by mixing uranium dioxide (UO₂) having ceramic properties with metallic thorium (Th) to enable neutrons released during nuclear fission of U-235 to breed thorium, and conversion of the bred thorium into a nuclear fissile material, that is, U-233, thereby ensuring continuous nuclear fission and ultimately enhancing economical effects of fuels.

2. Description of the Related Art

Existing nuclear fuels utilizing thorium breeding include a mixture of thorium and concentrated uranium. Such a material is irradiated and burned at a reactor core. In this regard, the above nuclear fuel is substantially (Th, U)O2 having ceramic properties, prepared by mixing a thorium dioxide with uranium dioxide in a predetermined ratio. This nuclear fuel in a blanket form is bred at a constant place of the reactor core, and then combusted. Otherwise, the above nuclear fuel is directly burned at the reactor core.

More particularly, thermal energy generated by nuclear fission of U-235 is initially used at a begin operating cycle and, thereafter, Th-232 absorbs thermal neutrons released during U-235 nuclear fission to form U-233, in turn enabling use of such U-233 as a nuclear fissile material. The foregoing technologies involve obvious advantages and disadvantages in terms of technical restrictions and economic feasibility, respectively.

Among conventional technologies, seed-and-blanket type nuclear fuels are used for breeding by placing thorium dioxide and uranium or plutonium dioxide at different positions and, in a nuclear power plant, such seed-and-blanket type nuclear fuel is generally used together with a mixture comprising thorium dioxide and uranium or plutonium dioxide in a predetermined ratio, wherein the mixture is located on a desired place. Such technologies for use of thorium optionally cause adverse effects in aspect of nuclear non-proliferation, have difficulties in nuclear reprocessing due to Th-228 having high radioactivity, and entail technical problems in production thereof.

On the other hand, if conventional problems of mixed nuclear fuels containing thorium are overcome, the nuclear power plant may be operated once-through and/or for extra-long term, occurrence of a high burn-up structure at high burn-up may be delayed to thereby remarkably improve overall reactor performance, as compared to existing nuclear fuels. Since thorium dioxide has thermal conductivity of 5.52 W/mK while metallic thorium has thermal conductivity of 54 W/mK in the operating temperature range of a nuclear power plant, thermal conductivity of the latter, that is, metallic thorium is about 10 times higher than that of the former, that is, thorium dioxide. Accordingly, when using metallic thorium as the nuclear fuel, heat generated from the nuclear fuel may easily be delivered to a coolant, in turn rapidly decreasing a temperature in the center of the nuclear fuel. Such reduced temperature of the nuclear fuel may have an advantage of decreasing release of nuclear fission gas.

### SUMMARY OF THE INVENTION

Therefore, in consideration of technical matters described above, the present invention is generally directed to a novel concept of original technologies regarding nuclear fuels, which includes provision of a process for preparation of a breading nuclear fuel mixture containing metallic thorium, so as to enable nuclear transfer and utilization of thorium as an energy source, thereby enhancing economical efficiency.

An object of the present invention is to provide a breeding nuclear fuel mixture containing metallic thorium, prepared by; uniformly distributing ceramic type uranium dioxide, which is formed of small spherical particles, over metallic thorium by a high temperature forming process to prepare pellets, and inserting the pellets into a nuclear fuel cladding tube or cladding material, thereby forming a nuclear fuel rod. As a result, thermal energy as a primary thermal source (that is, heat) generated by nuclear fission of U-235 may be rapidly transferred to cooling water through metallic thorium having high thermal conductivity, while thorium may absorb thermal neutrons released during U-235 nuclear fission to form U-233 and use a secondary thermal source generated by nuclear fission of the formed U-233.

In order to accomplish the foregoing objects, there is provided a mixed nuclear fuel prepared by homogeneously mixing spherical uranium dioxide (UO₂) particles with metallic thorium, in order to enable nuclear fission of U-235 and conversion of bred thorium into a nuclear fissile material, U-233, thereby utilizing continuous nuclear fission of U-233.

Alternatively, there is provided a mixed nuclear fuel prepared by homogeneously mixing spherical particles of combined UO₂ or plutonium dioxide (PuO₂) with metallic thorium (Th), thus enabling continuous nuclear fission.

The foregoing mixed nuclear fuel described above comprises uranium dioxide (UO₂) and thorium (Th) in a predetermined mixing ratio of 1:1.

According to another aspect of the present invention, there is provided a nuclear fuel bundle comprising a plurality of nuclear fuel rods, each of which is fabricated by loading a solid pellet prepared using the mixed nuclear fuel as set forth above, into a cladding tube. Alternatively, there is also provided a nuclear fuel bundle comprising a plurality of nuclear fuel rods, each of which is fabricated by loading a cylindrical pellet prepared using the mixed nuclear fuel as set forth above, between an outer tube and an inner tube of a double-cladding tube system.

The mixed nuclear fuel may be fabricated by forming an angular rod type pellet having a polygonal cross-section and loading the pellet into each flow hole of a graphite body. Alternatively, a plate type nuclear fuel fabricated by covering the mixed nuclear fuel described above with a metallic cladding material may also be used.

Before using a mixed nuclear fuel in a nuclear power plant, it is preferable to optimally blend UO₂ and thorium by analyzing nuclear properties of a reactor core in the nuclear power plant and to secure economical benefits of the nuclear power plant based on thermal hydraulic analysis.

A breeding nuclear fuel mixture containing metallic thorium according to the present invention has higher thermal conductivity than that of a typical nuclear fuel, CERCER (Th, U)O₂, for breeding thorium according to existing concepts, thereby considerably decreasing a temperature of the center of nuclear fuel. Consequently, safety and thermal margin of a nuclear power plant may be conveniently ensured.

Meanwhile, since Th-232 begins to be bred into U-233 and burned at the approximately 25 to 30 MWd/kgU, the present invention may enable extra-long term operation of a reactor core, thus ultimately maximizing economic efficiency of a nuclear power plant.

Accordingly, it is anticipated that a variety of nuclear reactor systems may be economically designed using the inventive nuclear fuel.

Specifically, when the inventive nuclear fuel is applied to a nuclear reactor, creep rate of the nuclear fuel may be reduced while attaining high PCMI resistance since metallic thorium has excellent flexibility. Due to a relatively low temperature of a pellet, diffusion of nuclear fission gas may not be so much, thus maintaining a low level of a nuclear fuel rod internal pressure. As a result, it is presumed that excellent nuclear fuel integrity and superior performance enabling extra-long term operation may be attained.

Moreover, since thorium resources which are at least 4 to 5 times more abundant in nature than all uranium resources are effectively employed, thorium may prepare for the exhaustion of uranium resources and have an important role as a future energy resource.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptive view illustrating a breeding nuclear fuel mixture containing metallic thorium according to the present invention;

FIG. 2 is a perspective projection view illustrating both a bundle cell and a border cell of a breeding nuclear fuel mixture containing metallic thorium according to the present invention;

FIG. 3 is a perspective view illustrating a solid pellet of a mixed nuclear fuel for a light water reactor type nuclear power plant, which is prepared using a breeding nuclear fuel mixture containing metallic thorium according to the present invention;

FIG. 4 is schematic views illustrating a mixed nuclear fuel bundle for a light water reactor type nuclear power plant, which is prepared using the solid pellets shown in FIG. 3, as well as the solid pellet loaded into a nuclear fuel cladding tube;

FIG. 5 is a perspective view illustrating a block type pellet prepared using a breeding nuclear fuel mixture containing metallic thorium according to the present invention;

FIG. 6 is a schematic perspective view illustrating a partially exploded part of a nuclear reactor core for breeding, loaded with a plurality of block type pellets shown in FIG. 5;

FIG. 7 is cross-sectional view and perspective view illustrating a cylindrical pellet as a double-cooled nuclear fuel for a light water reactor type nuclear power plant, which is prepared using a breeding nuclear fuel mixture containing metallic thorium according to the present invention and, in addition, a schematic cross-sectional view illustrating a exterior/interior-cladding tube loaded with a plurality of cylindrical pellets;

FIG. 8 is cross-sectional view and perspective view illustrating a partially exploded part of a plate type nuclear fuel, which comprises a breeding nuclear fuel mixture containing metallic thorium according to the present invention; and

FIG. 9 is cross-sectional view and schematic view illustrating a plate type nuclear fuel bundle for a research reactor and/or a small modular reactor (SMR), in which the plate type nuclear fuel shown in FIG. 8 is provided.

### DETAILED DESCRIPTION

The present invention will now be described more fully hereinafter with reference to the accompanying drawings forming a part of this specification wherein like reference characters designate corresponding parts in the several views. In the embodiments of the present invention, detailed description of the publicly known functions and configurations that are judged to be able to make the purport of the present invention unnecessarily obscure are omitted.

A major feature of the present invention is to provide a nuclear fuel in typical sintered forms (such as pellets) by forming ceramic type UO₂ into spherical fuel particles through a conventional gel-sol process or other methods, and then, homogeneously distributing such particles over metallic thorium (Th) having a melting point of 1842° C. through hot press forming. The prepared nuclear fuel is introduced into a nuclear fuel cladding tube, and the cladding tube is placed in a reactor core of a nuclear power plant. In addition, the prepared ceramic type UO₂ may also be replaced by spherical particles of combined UO₂ and plutonium dioxide (PuO2).

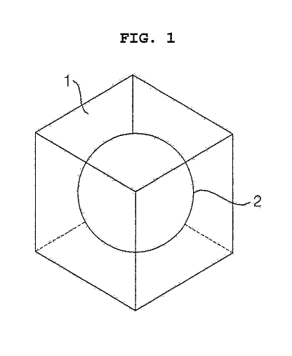

FIG. 1 is a representative view illustrating an internal configuration of a breeding nuclear fuel mixture containing metallic thorium according to the present invention, wherein metallic thorium (Th) 1 and uranium dioxide (UO₂) 2 form a unit cell. More particularly, UO₂ in the form of spherical particles is homogeneously distributed in the metallic thorium. Here, a mixing ratio of UO₂ to Th is preferably 1:1, however, this may vary depend on purposes of using the same.

Therefore, as described above, when blending UO₂ and Th in a suitable mixing ratio in consideration of nuclear properties thereof, Th-232 may absorb neutrons released by nuclear fission of U-235 at a reactor core of a nuclear reactor to form Th-233, which in turn lead to a breeding process such that the formed Th-233 is converted into a nuclear fuel material based on U-233, through gamma decay and beta decay. Accordingly, a mixed nuclear fuel, which comprises UO₂ having physical properties of ceramics and Th having metallic properties, may be burned over a long period of time at a reactor core of a nuclear power plant, thereby increasing utilization of the nuclear power plant and preserving limited uranium resources as much as possible.

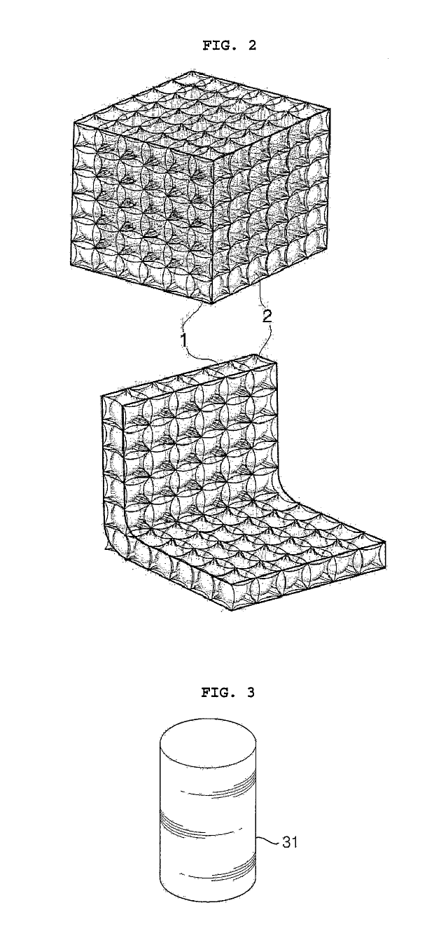

Meanwhile, bundling such unit cells of metallic thorium 1 and UO₂ 2 may form a bundle cell or a border cell, as shown in FIG. 2.

As described above, FIG. 3 is a three-dimensional perspective projection view illustrating a solid pellet 31, as a nuclear fuel for a light water reactor type nuclear power plant, prepared using a breeding nuclear fuel mixture containing metallic thorium obtained by mixing metallic thorium 1 with UO₂ 2 in a suitable mixing ratio, in order to form a nuclear fuel for a light water reactor type nuclear power plant.

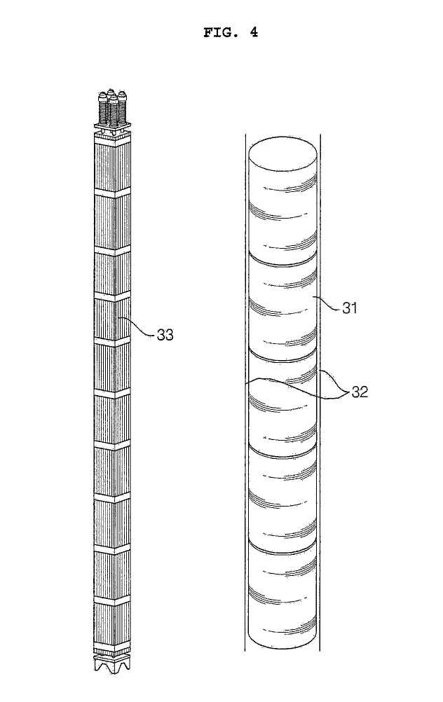

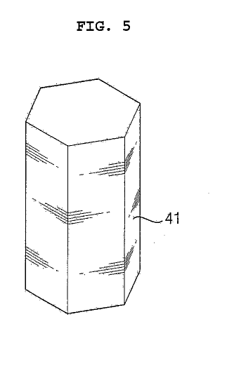

FIG. 4 is a perspective projection view and three-dimensional view illustrating a cladding tube 32 of a nuclear fuel bundle 33 for a light water reactor type nuclear power plant loaded with the solid pellet 31 shown in FIG. 3.

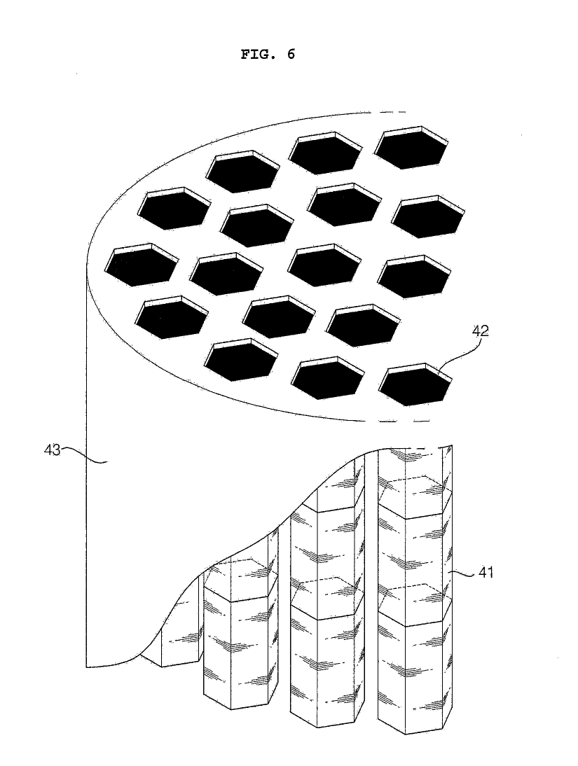

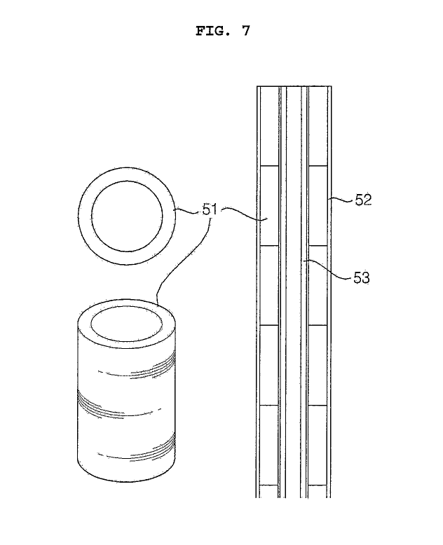

FIG. 5 is a perspective view illustrating an angular rod type pellet 41 having a hexagonal cross-section, which is a sintered material prepared using a breeding nuclear fuel mixture containing metallic thorium according to an embodiment of the present invention. FIG. 6 is an illustrative view showing a plurality of angular rod type pellets 41 loaded into flow holes 42 of a graphite body 43.

FIG. 7 is cross-sectional view and perspective view illustrating a cylindrical pellet 51, which is a sintered material prepared using a breeding nuclear fuel mixture containing metallic thorium according to another embodiment of the present invention. The cross-sectional view schematically illustrates a plurality of cylindrical pellets 51 loaded between an exterior tube 52 and an interior tube 53 of a double-cladding tube system.

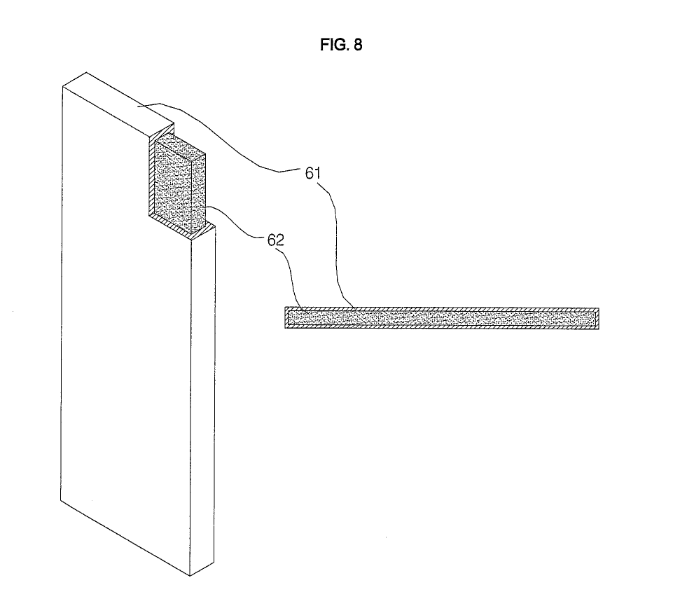

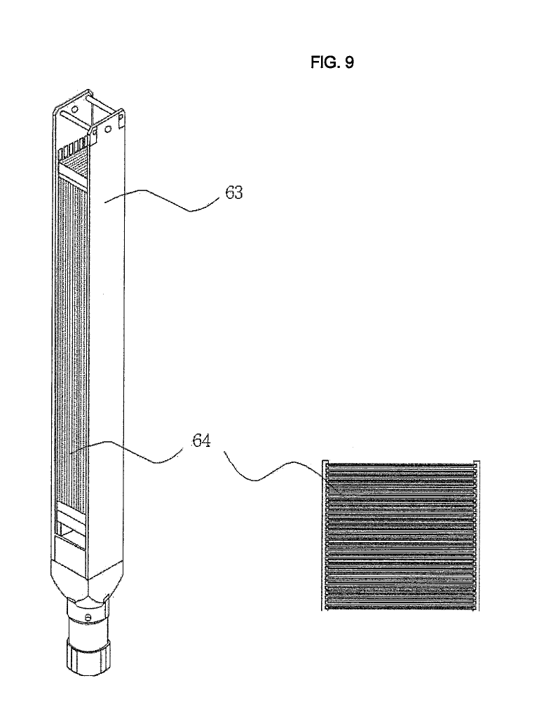

FIG. 8 is cross-sectional view and perspective view illustrating a nuclear fuel cladding material 61 having planar cross-section and a mixed nuclear fuel material 62 loaded in the nuclear fuel cladding material, which comprises a breeding nuclear fuel mixture containing metallic thorium according to another embodiment of the present invention. FIG. 9 is schematic views illustrating a plate type nuclear fuel bundle 63 and cross-section 64 of a nuclear fuel in the bundle.

While the present invention has been described with reference to the preferred embodiments, it will be understood by those skilled in the related art that various modifications and variations may be made therein without departing from the scope of the present invention as defined by the appended claims.

What is claimed is:

1. A mixed nuclear fuel, prepared by:
homogeneously mixing uranium dioxide (UO₂) in the form of spherical particles with a metallic thorium, wherein thorium is bred by neutrons released during nuclear fission of U-235 and the bred thorium is converted into a novel nuclear fissile material, that is, U-233, thus enabling continuous nuclear fission.

2. A mixed nuclear fuel, prepared by:
homogeneously mixing spherical particles of a combined uranium dioxide (UO₂) and plutonium dioxide (PuO₂) with metallic thorium (Th), thus enabling continuous nuclear fission.

3. The mixed nuclear fuel according to claim 1, wherein UO₂ and thorium are mixed in a predetermined ratio.

4. A nuclear fuel bundle comprising a plurality of nuclear fuel rods, each of which is fabricated by loading a solid pellet prepared using the mixed nuclear fuel as set forth in claim 1, into a cladding tube.

5. A nuclear fuel bundle comprising a plurality of nuclear fuel rods, each of which is fabricated by loading a cylindrical pellet prepared using the mixed nuclear fuel as set forth in claim 1, between an exterior tube and an interior tube of a double-cladding tube system.

6. A sintered nuclear fuel for a nuclear power plant, fabricated by forming an angular rod type pellet having a polygonal cross-section, using the mixed nuclear fuel as set forth in claim 1, and loading the pellet into each flow hole of a graphite body.

7. A plate type nuclear fuel bundle comprising a plurality of plate type nuclear fuels, each of which is fabricated by loading the mixed nuclear fuel as set forth in claim 1, in a plate type cladding material.

8. A nuclear fuel bundle comprising a plurality of nuclear fuel rods, each of which is fabricated by loading a solid pellet prepared using the mixed nuclear fuel as set forth in claim 2, into a cladding tube.

9. A nuclear fuel bundle comprising a plurality of nuclear fuel rods, each of which is fabricated by loading a cylindrical pellet prepared using the mixed nuclear fuel as set forth in claim 2, between an exterior tube and an interior tube of a double-cladding tube system.

10. A sintered nuclear fuel for a nuclear power plant, fabricated by forming an angular rod type pellet having a polygonal cross-section, using the mixed nuclear fuel as set forth in claim 2, and loading the pellet into each flow hole of a graphite body.

11. A plate type nuclear fuel bundle comprising a plurality of plate type nuclear fuels, each of which is fabricated by loading the mixed nuclear fuel as set forth in claim 2, in a plate type cladding material.
